(19) United States
(12) Patent Application Publication
(10) Pub. No.: US 2012/0116682 A1
(43) Pub. Date: May 10, 2012

(54) ENERGY DENSITY AND STRESS IMAGING CONDITIONS FOR SOURCE LOCALIZATION AND CHARACTERIZATION

(75) Inventor: Erik Hans Saenger, Zurich (CH)

(73) Assignee: SPECTRASEIS AG, Zurich (CH)

(21) Appl. No.: 13/383,928

(22) PCT Filed: Dec. 15, 2010
(86) PCT No.: PCT/US10/60370

§ 371 Date: Jan. 13, 2012

Related U.S. Application Data
(60) Provisional application No. 61/286,495, filed on Dec. 15, 2009.

(51) Int. Cl. G06F 19/00; G01V 1/30; G01V 1/34

(52) U.S. Cl. 702/16

(57) ABSTRACT

A method and system for processing synchronous array seismic data includes acquiring synchronous seismic data from a plurality of sensors to obtain synchronized array measurements. A reverse-time data propagation process is applied to the synchronized array measurements to obtain dynamic particle parameters associated with subsurface locations. A maximum energy density imaging condition is applied to the dynamic particle parameters to obtain imaging values associated with subsurface locations. Subsurface positions of energy sources are located from the relative maximum of a plurality of the imaging values associated with subsurface locations.

### CROSS-REFERENCE TO RELATED APPLICATION

This application claims the benefit of U.S. Provisional Application No. 61/286,495 filed 15 Dec. 2009, which is fully incorporated by reference.

### BACKGROUND OF THE DISCLOSURE

1. Technical Field

The disclosure is related to seismic exploration for oil and gas, and more particularly to determination of the positions of subsurface reservoirs.

2. Description

Geophysical and geological exploration investment for hydrocarbons is often focused on acquiring data in the most promising areas using relatively slow methods, such as reflection seismic data acquisition and processing. The acquired data are used for mapping potential hydrocarbon-bearing areas within a survey area to optimize exploratory or production well locations and to minimize costly non-productive wells.

The time from mineral discovery to production may be shortened if the total time required to evaluate and explore a survey area can be reduced by applying geophysical methods alone or in combination. Some methods may be used as a standalone decision tool for oil and gas development decisions when no other data is available.

Geophysical and geological methods are used to maximize production after reservoir discovery as well. Reservoirs are analyzed using time lapse surveys (i.e. repeat applications of geophysical methods over time) to understand reservoir changes during production. The process of exploring for and exploiting subsurface hydrocarbon reservoirs is often costly and inefficient because operators have imperfect information from geophysical and geological characteristics about reservoir locations. Furthermore, a reservoir's characteristics may change as it is produced.

The impact of oil exploration methods on the environment may be reduced by using low-impact methods and/or by narrowing the scope of methods requiring an active source, including reflection seismic and electromagnetic surveying methods. Various geophysical data acquisition methods have a relatively low impact on field survey areas. Low-impact methods include gravity and magnetic surveys that maybe used to enrich or corroborate structural images and/or integrate with other geophysical data, such as reflection seismic data, to delineate hydrocarbon-bearing zones within promising formations and clarify ambiguities in lower quality data, e.g. where geological or near-surface conditions reduce the effectiveness of reflection seismic methods.

### SUMMARY

A method and system for processing synchronous array seismic data includes acquiring synchronous passive seismic data from a plurality of sensors to obtain synchronized array measurements. A reverse-time data process is applied to the synchronized array measurements to obtain a plurality of dynamic particle parameters associated with subsurface locations. Output from an energy density imaging condition is applied to the dynamic particle parameters to obtain an image.

### BRIEF DESCRIPTION OF THE DRAWINGS

FIG. 1 is a schematic illustration of a method according to an embodiment of the present disclosure for calculating maximum values for subsurface locations from continuous synchronous signals;

FIG. 2 illustrates various non-limiting possibilities for arrays of sensor for data acquisition of synchronous signals;

FIG. 3 is a flow chart of reverse-time processing for application to seismic data;

FIG. 4 is a flow chart of a data processing flow that includes acquiring or determining a velocity model associated with reverse-time processing of field data;

FIG. 5 illustrates a flow chart of an embodiment according to the present disclosure;

FIG. 6 illustrates the maximum energy density given by equation 12 with two source positions apparent;

FIG. 7 illustrates the maximum energy density given by equation 12 with no source positions apparent where the method is applied to random data;

FIG. 8 illustrates a flow chart of an embodiment according to the present disclosure;

FIG. 9 is diagrammatic representation of a machine in the form of a computer system within which a set of instructions, when executed may cause the machine to perform any one or more of the methods and processes described herein.

### DETAILED DESCRIPTION

Information to determine the location of hydrocarbon reservoirs may be extracted from naturally occurring seismic waves and vibrations measured at the earth's surface using seismic data. Seismic wave energy emanating from subsurface reservoirs, or otherwise altered by subsurface reservoirs, is detected by arrays of sensors and the energy back-propagated with reverse-time processing methods to locate the source of the energy disturbance. An inversion methodology for locating positions of subsurface reservoirs may be based on various time reversal processing algorithms of time series measurements of passive seismic data.

Passive seismic data acquisition methods rely on seismic energy from sources not directly associated with the data acquisition. In passive seismic monitoring there may be no actively controlled and triggered source. Examples of sources recorded that may be recorded with passive seismic acquisition are microseisms (e.g., rhythmically and persistently recurring low-energy earth tremors), microtremors and other ambient or localized seismic energy sources. The methods and systems disclosed herein are applicable to seismic data whether or not the data are considered to be passively acquired.

Microtremors are attributed to the background energy normally present in the earth. Microtremor seismic waves may include sustained seismic signals within various or limited frequency ranges. Microtremor signals, like all seismic waves, contain information affecting spectral signature characteristics due to the media or environment that the seismic waves traverse as well as the source of the seismic energy. These naturally occurring and often relatively low frequency background seismic waves (sometimes termed noise or hum) of the earth may be generated from a variety of sources, some of which may be unknown or indeterminate.

Characteristics of microtremor seismic waves may contain relevant information for direct detection of subsurface properties including the detection of fluid reservoirs. Synchronous arrays of sensors are used to measure vertical and horizontal components of motion due to background seismic waves at multiple locations within a survey area.

Local acquisition conditions within a geophysical survey may affect acquired data results. Acquisition conditions impacting acquired signals may change over time and may be diurnal. Other acquisition conditions are related to the near sensor environment. These conditions may be accounted for during data reduction.

The sensor equipment for measuring seismic waves may be any type of seismometer for measuring particle dynamics, such as particle displacements or derivatives of displacements. Seismometer equipment having a large dynamic range and enhanced sensitivity compared with other transducers, particularly in low frequency ranges, may provide optimum results (e.g., multicomponent earthquake seismometers or equipment with similar capabilities). A number of different types of sensors utilizing different technologies may be used, e.g. a balanced force feed-back instrument or an electrochemical sensor. An instrument with high sensitivity at very low frequencies and good coupling with the earth enhances the efficacy of the method.

Noise conditions representative of seismic waves that may have not traversed or been affected by subsurface reservoirs can negatively affect the recorded data. Techniques for removing unwanted noise and artifacts and artificial signals from the data, such as cultural and industrial noise, are important where ambient noise is relatively high compared with desired signal energy.

Time-reverse data processing may be used to localize relatively weak seismic events or energy, for example if a reservoir acts as an energy source or significantly affects seismic energy traversing the reservoir. The seismograms measured at a synchronous array of sensor stations are reversed in time and used as boundary values for the reverse processing. Time-reverse data processing is capable of providing indications for locations of energy sources when data have a signal to noise ratio lower than one.

Field surveys have shown that hydrocarbon reservoirs may act as a source of low frequency seismic waves and these signals are sometimes termed “hydrocarbon microtremors.” The frequency ranges of microtremors have been reported between ˜1 Hz to 6 Hz or greater. A direct and efficient detection of hydrocarbon reservoirs is of central interest for the development of new oil or gas fields. One approach is to apply a time-reverse processing/migration. If there is a steady source origin (or other alteration) of low-frequency seismic waves within a reservoir, the location of the reservoir may be located using time reverse migration and may also be used to locate and differentiate stacked reservoirs.

Time reverse processing (or migration) of acquired seismic data, which may be in conjunction with modeling, using a grid of nodes is an effective tool to detect the locality of a steady origin of low-frequency seismic waves. As a non-limiting example for the purposes of illustration, microtremors may comprise low-frequency signals with a fundamental frequency of about 3 Hz and a range between 1.5 Hz and 4.5 Hz. In contrast, the data used to illustrate embodiments of the present invention are in the kHz range, but the principles are the same. Hydrocarbon affected seismic data that include microtremors may have differing values that are reservoir or case specific. Snapshots (images of an inversion representing one or more time steps) showing a current dynamic particle motion value (e.g., displacement, velocity, acceleration or pressure) at every grid point may be produced at specific time steps during the reverse-time signal processing. Data for nodes representing high or maximum particle velocity values indicate the location of a specific source (or a location related to seismic energy source aberration) of the forward or field acquired data. The maximum velocities obtained from the reverse-time data processing may be used to delineate parameters associated with the subsurface reservoir location.

There are many known methods for a reverse-time data process for seismic wave field imaging with Earth parameters from inversions of acquired seismic data. For example, finite-difference, ray-tracing and pseudo-spectral computations, in two- and three-dimensional space, are used for full or partial wave field simulations and imaging of seismic data. Reverse-time migration algorithms may be based on finite-difference, ray-tracing or pseudo-spectral wave field extrapolators. Output from these reverse-time data processing routines may include amplitudes for displacement, velocity, acceleration or pressures values at every time steps of the inversion. Various imaging conditions may be applied to the output.

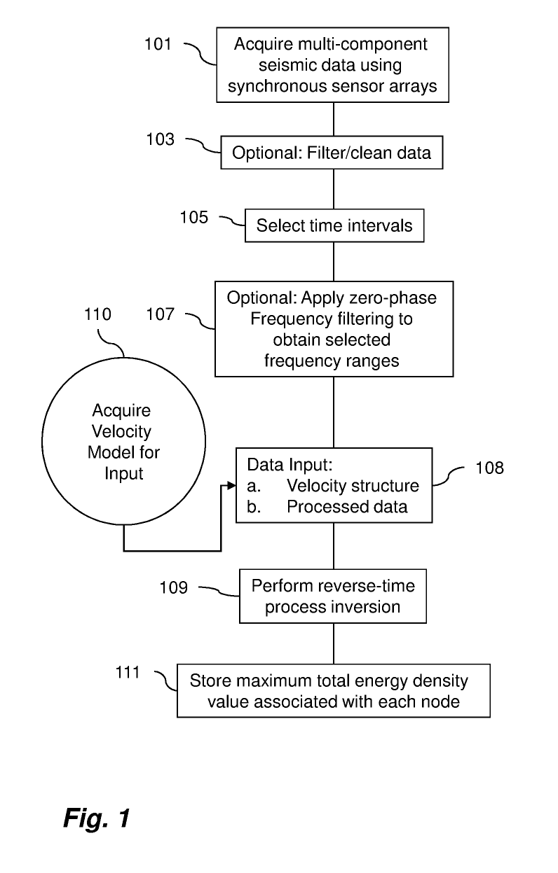

FIG. 1 illustrates a method according to a non-limiting embodiment of the present disclosure that includes using acquired seismic data to determine a subsurface location for hydrocarbons or other reservoir fluids. The embodiment, which may include one or more of the following (in any order), includes acquiring synchronous array seismic data having a plurality of components 101. The acquired data from each sensor station may be time stamped and include multiple data vectors. An example is seismic data, such as multicomponent seismometry data from “earthquake” type sensors. The multiple data vectors may each be associated with an orthogonal direction of movement. Data may be acquired as orthogonal component vectors. The vector data may be arbitrarily mapped or assigned to any coordinate reference system, for example designated east, north and depth (e.g., respectively, Ve, Vn and Vz) or designated Vₓ, V_{y} and V_{z} according to any desired convention and is amenable to any coordinate system.

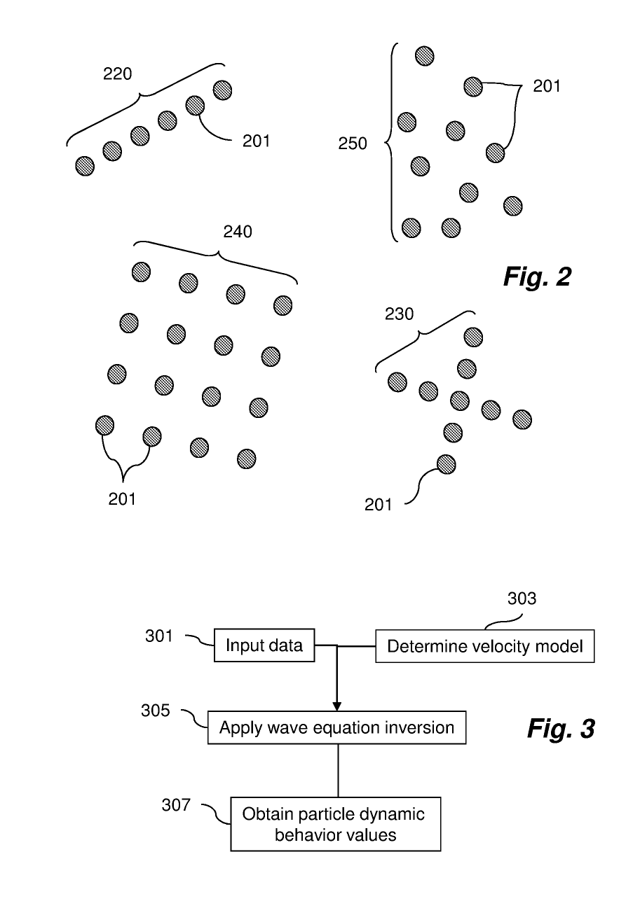

Data may be acquired with arrays, which may be 2D or 3D, or even arbitrarily positioned sensors 201 as illustrated in FIG. 2. FIG. 2 illustrates various acquisition geometries which may be selected based on operational considerations. Array 220 is a 2D array and while illustrated with regularly spaced sensors 201, regular distribution is not a requirement. Array 230 and 240 are example illustrations of 3D arrays. Sensor distribution 250 could be considered an array of arbitrarily placed sensors and may even provide for some modification of possible spatial aliasing that can occur with regular spaced sensor 201 acquisition arrays.

While data may be acquired with multi-component earthquake seismometer equipment with large dynamic range and enhanced sensitivity, many different types of sensor instruments can be used with different underlying technologies and varying sensitivities. Sensor positioning during recording may vary, e.g. sensors may be positioned on the ground, below the surface or in a borehole. The sensor may be positioned on a tripod or rock-pad. Sensors may be enclosed in a protective housing for ocean bottom placement. Wherever sensors are positioned, good coupling results in better data. Recording time may vary, e.g. from minutes to hours or days. In general terms, longer-term measurements may be helpful in areas where there is high ambient noise and provide extended periods of data with fewer noise problems.

The layout of a data survey may be varied, e.g. measurement locations may be close together or spaced widely apart and different locations may be occupied for acquiring measurements consecutively or simultaneously. Simultaneous recording of a plurality of locations (a sensor array) may provide for relative consistency in environmental conditions that may be helpful in ameliorating problematic or localized ambient noise not related to subsurface characteristics of interest. Additionally the array may provide signal differentiation advantages due to commonalities and differences in the recorded signal.

Returning to FIG. 1, the data may be optionally conditioned or cleaned as necessary 103 to account for unwanted noise or signal interference. For example various processing steps such as offset removal, detrending the signal and band pass or other targeted frequency filtering. The vector data may be divided into selected time windows 105 for processing. The length of time windows for analysis may be chosen to accommodate processing or operational concerns.

If a preferred or known range of frequencies for which a hydrocarbon signature is known or expected, an optional frequency filter (e.g., zero phase, Fourier of other wavelet type) may be applied 107 to condition the data for processing. Examples of basis functions for filtering or other processing operations include without limitation the classic Fourier transform or one of the many Continuous Wavelet Transforms (CWT) or Discreet Wavelet Transforms. Examples of other transforms include Haar transforms, Haademard transforms and Wavelet Transforms. The Morlet wavelet is an example of a wavelet transform that often may be beneficially applied to seismic data. Wavelet transforms have the attractive property that the corresponding expansion may be differentiable term by term when the seismic trace is smooth.

Additionally, signal analysis, filtering, and suppressing unwanted signal artifacts may be carried out efficiently using transforms applied to the acquired data signals. Additionally the data may be resampled 108 to facilitate more efficient processing.

The earth velocity model or velocity structure, which may be developed from predetermined subsurface velocity information, for use with the reverse-time processing may be input to the work flow at virtually any point, but is illustrated here as an example. The velocity model may be resampled to facilitate data processing as well.

Inverting field-acquired passive seismic data to determine the location of subsurface reservoirs includes using the acquired time-series data as ‘sources’ in reverse-time processing 109. The output of the reverse-time processing includes a measure of the dynamic particle motion of sources associated with subsurface positions (which may be nodes of mathematical descriptions (i.e., models) of the earth). The maximum energy density values derived from dynamic particle motion output from reverse time migration, which may be displacements, velocities or accelerations, may be collected 111 to determine the energy source location. Plotting the maximum dynamic values from all the measurement values output from a reverse-time process may provide a basis for interpreting the location of the energy source, which could be a subsurface reservoir. The amplitude values associated with subsurface locations having the highest relative values may indicate the position of a reservoir that is the source of hydrocarbon tremors. An alternative to checking and storing an updated maximum for every backward time step is to sum together all the values calculated for each time step or subsurface position. The data, whether maximum values or summed values, may be contoured or otherwise graphically displayed to illuminate reservoir positions.

A non-limiting example of a reverse-time processing inversion is illustrated in FIG. 3 wherein data are input 301 to the processing flow. The data may optionally be filtered to a selected frequency range. A velocity model for the reverse-time process may be determined from known information 303 or estimated. A wave-equation reverse-time inversion is performed 305 to obtain particle dynamic behavior 307.

The reverse-time inversion process may include development of a model that may be based on a priori knowledge or estimates of a survey area of interest. During data preparation, the forward modeling inversion may be useful for anticipating and accounting for known seismic signal or refining the velocity field used for the reverse time processing. Modeling may include accounting for, or the removal of, the near sensor signal contributions due to environmental field effects, unwanted signal and noise and, thus, the isolation of those parts of signals believed to be associated with environmental components being examined.

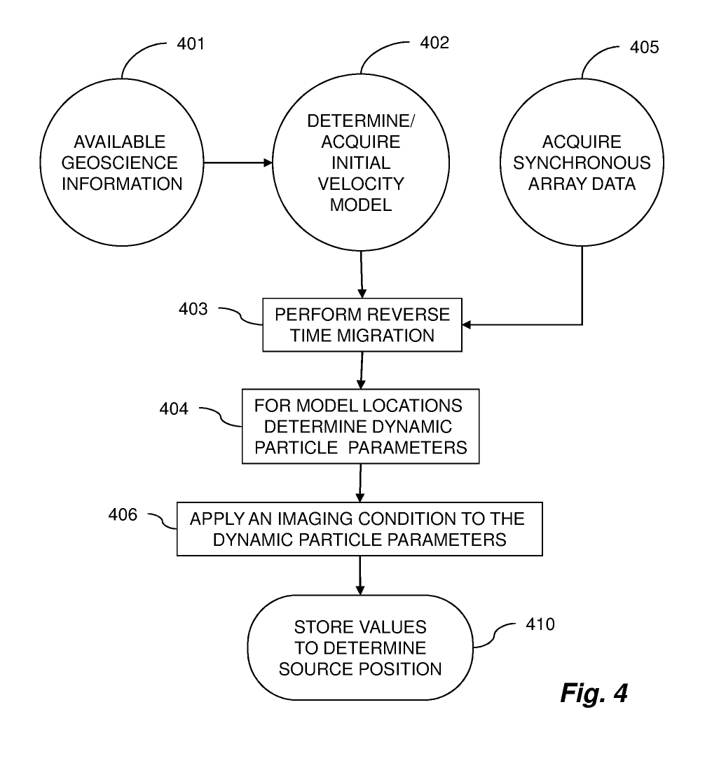

FIG. 4 illustrates an example of a reverse-time process inversion for locating a reservoir in the subsurface using a velocity model 402 as input for a reverse-time migration of continuous signals. The reverse time migration may be wave equation based. Any available geosciences information 401 may be used as input to determine parameters for an initial model 402 that may be modified as input to a reverse-time data process for continuous signals 403 as more information is available or determined. Synchronously acquired seismic data 405 are input (after any optional processing/conditioning) to the reverse-time data process 403. Particle dynamics such as displacement, velocity or acceleration (or pressure) are determined from the processed data for determining dynamic particle behaviour 404. An imaging condition (e.g. maximum energy density imaging condition) may be applied 406 during the inversion and stored 410 to determine subsurface reservoir positions.

The maximum amplitude values associated with the dynamic particle behavior, such as velocity values, or in the present case stress and strain is used to calculate an imaging condition, represent the location of sources of hydrocarbon tremors. Unlike prior art time-reverse methods, there is no specific time associated with the source, since the tremor as the source is a continuous function unlike discrete seismic events. Not only the tremor source may be located, but noise sources not related to tremor sources may be differentiated as well.

An example of an embodiment illustrated here uses a numerical modeling algorithm similar to the rotated staggered grid finite-difference technique described by Saenger et al. (2000). The two dimensional numerical grid is rectangular. Computations may be performed with second order spatial explicit finite difference operators and with a second order time update. However, as will be well known by practitioners familiar with the art, many different reverse-time methods may be used along with various wave equation approaches. Extending methods to three dimensions is straightforward.

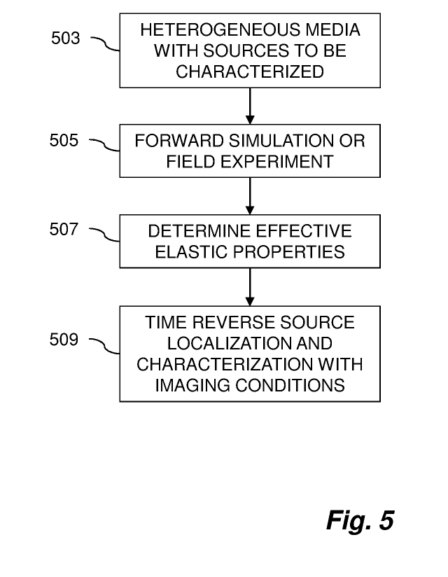

For a non-limiting illustrative example used to develop the methods disclosed herein, a model data set rather than acquired data are input. The methodology is illustrated in FIG. 5. Starting point is an arbitrary heterogeneous media where a source of wave energy has to be localized and characterized 503. The induced wavefield is measured with a finite number of receivers. For the time-reverse simulation itself the heterogeneous media will be represented by a velocity model based on effective elastic properties Saenger (2008). By analyzing the pattern of the applied imaging conditions it is possible to invert for the source characteristics (e.g. momentum tensor). This methodology can be used for the characterization of microseismic events and low-frequency exploration geophysics. The present example is derived from numerical experiments on concrete, but the imaging condition applies directly to seismic data processing to locate subsurface energy locations. A forward simulation or field experiment may be conducted 505 to obtain data signals for input to the Source TRM. A determination of the effective elastic properties of the media is conducted 507 as well. Time reverse source localization and characterization is conducted 509.

A standard forward computation is utilized to produce boundary signals which enter TRM simulations. In this example the so-called rotated staggered finite difference scheme is applied to discretize the wave equation. In forward computations the initial displacement and velocity are not directly initialized but generated in the first time steps by a momentum tensor source. Hence, the initial conditions are set to

Uᵢ=Vᵢ=0 (1)

while the two moment tensor sources are chosen to be

$$\begin{matrix}{M}_{zz} ( x , t ) = 0 & ( 2 ) \\ {M}_{zx} ( x , t ) = {M}_{xx} ( x , t ) = \{ \begin{matrix}{R}_{i} ( x , t ) & t ∈ [ 0 , {t}_{s} ] \\ 0 & t > {t}_{s}\end{matrix} & ( 3 )\end{matrix}$$

which vanishes for t>tₛ with a start-up time tₛ<<T. Typically, Rᵢ is chosen localized in space around a position xₛ with a specific excitation pattern, for a example a second derivative of a Gaussian (f_{fund}=200 kHz, Δt=1.6×10⁻⁸). After time tₛ a localized non-vanishing displacement field is generated which can be considered as actual initial conditions emitting waves towards the boundaries. The aim of the TRM simulation below is to find an approximation to the original source position xₛ and the source characteristic.

To implement free surface boundary conditions on a medium specimen easily, the computational domain is extended around Ω by 2 grid cells which represent an almost vacuum state, that is, containing a vanishing stiffness tensor and density ρ_{g}^{(extern)}<<ρ_{g}^{(intern)}. Zero Dirichlet conditions are employed on the outer boundary of this vacuum layer which gives the boundary of the computational domain. For simplicity, Ω will always denote the domain of the medium specimen in the following.

Effective velocities of the numerical concrete sample are obtained using use a technique described in detail in Saenger and Shapiro (2002). A review of this and related methods is given in Saenger (2008). A body force plane source is applied at the top of the model. The plane wave generated in this way propagates through the numerical concrete model. With two horizontal planes of receivers at the top and at the bottom, it is possible to measure the time-delay of the peak amplitude of the mean plane wave caused by the inhomogeneous region. With the time-delay (compared to a homogeneous reference model) the effective velocity of the compressional and shear wave can be estimated. The source wavelet is the first derivative of a Gaussian with a dominant frequency of 12500 Hz and with a time increment of Δt=1.8×10⁻⁸. As a result, the effective compressional wave velocity is determined as v_{p,eff}=3987 m/s and the effective shear wave velocity as v_{s,eff}=2328 m/s.

During a forward computation values of displacement are recorded by receivers on the boundary ∂Ω of the specimen. The locations of the receivers are denoted by

S={x⁽¹⁾,x⁽²⁾, . . . x^{(N)}}⊂∂Ω (4)

where N is the total number of source positions. The time series of the displacement at position x^{(k)} is written

uᵢ^{(k)}(t)=uᵢ(x^{(k)},t) (5)

with time tε[0, T]. These time series serve as input data for a TRM simulation. The position arrangement can be varied to evaluate the reproduction ability of the TRM simulation. The TRM simulation is again based on the wave equation using the same coefficients from the forward computation as well as xεΩ and tε[0, T]. No body force is present throughout the computation, fᵢ=0. Initial conditions are given by

Uᵢ(x)=0,Vᵢ(x)=0 (6)

such that the equation is driven by boundary conditions. On ∂Ω the recorded signals uᵢ^{(k)} are fed as sources into the domain. Formally, we write

uᵢ(x,t)=uᵢ^{(k)}(T−t) for xεS⊂∂Ω (7)

uᵢ(x,t)=0 for xε∂Ω\S (8)

such that inhomogeneous Dirichlet data is given exclusively in the source locations S. Note, that the time series is fed into the computation backwards in time. Hence, the TRM simulation reverses the forward computation. The term Source TRM emphasizes the way the time-signals are implemented in the algorithm, i.e. as sources of wave excitations. Source TRM is not complete by definition in the sense that the equation is provided with time-reversed receiver-signals at every boundary-point. Only a few selected points are used. In brief, we do not provide the equation with the full set of information. It turns out that only a few boundary-points have to be provided with time-reversed signals to achieve very good results. Source TRM has also been applied successfully to real models, i.e. using receiver data (representing the forward simulation) to carry out a numerical time reverse simulation in order locate a real physical wave exciting source. Such a real data example within exploration geophysics can be found in Steiner et al. (2008).

In the numerical method the actual domain Ω is supplemented by a layer of almost vacuum with zero Dirichlet conditions at the outer computational boundary as described above. Hence, the time signals uᵢ^{(k)} are inserted inside the numerical grid on the boundary grid points ∂Ω of the medium specimen. To avoid scattering they are superimposed to any existing values at these grid-points that are the results of interior and surface waves. By this technique the signals are interpreted as time series of localized initial conditions whose evolutions are superimposed in a time-delayed manner.

The waves emitted from the boundary sources during a Source TRM simulation will interfere constructively in the displacement field. In order to display the result of this interference in a TRM simulation we introduce several imaging conditions in order to localize and characterize the two sources xₛ of the original initial condition. In order to consider the effect of randomly generated signals a specific test setup is used. For each of twelve sensors generated a signal with seven pulses with the same fundamental frequency as the original source signal. Those pulses are randomly distributed in time. The amplitude of the two components are always in phase but the relative strength is random.

The maximum particle displacement as an imaging condition was introduced by Steiner et al. (2008). Formally it is given by:

trmfield(x):=max∥ u̅(x,t)∥ for tε[0,T] (9)

for every point xεΩ. This means, in order to image the convergent wave focusing on the initial source, we store the maximum particle displacement for each grid point throughout the entire time of modeling.

Maximum P- and S-wave energy density: Formulas for the P- and S-wave energy density are given by Dougherty and Stephen (1988). Based on this Steiner (2009) has introduced the maximum P- and S-wave energy as imaging conditions for tε[0, T]:

pefield(x):=max(λ+4μ)[∇· u̅(x,t)]² (10)

sefield(x):=maxμ[∇× u̅(x,t)]² (11)

Maximum energy density imaging condition is based on the definition of the total energy density using stress σᵢⱼ and strain εᵢⱼ, for tε[0,T]:

gefield(x):=maxΣᵢΣⱼσᵢⱼ(x,t)εᵢⱼ(x,t) (12)

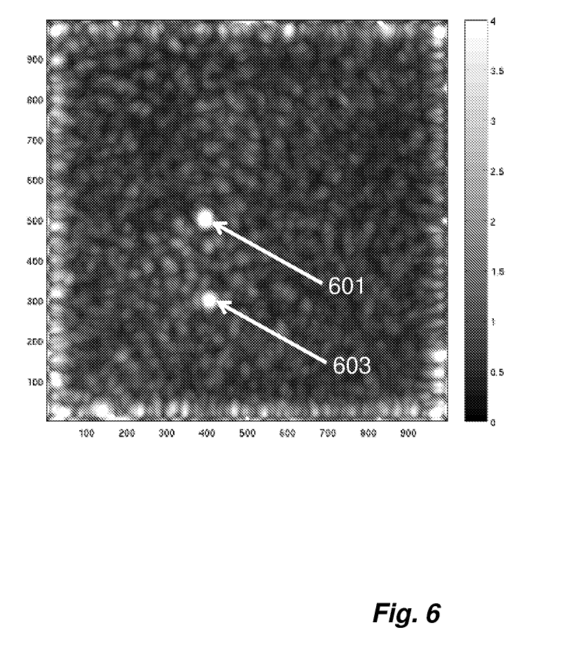

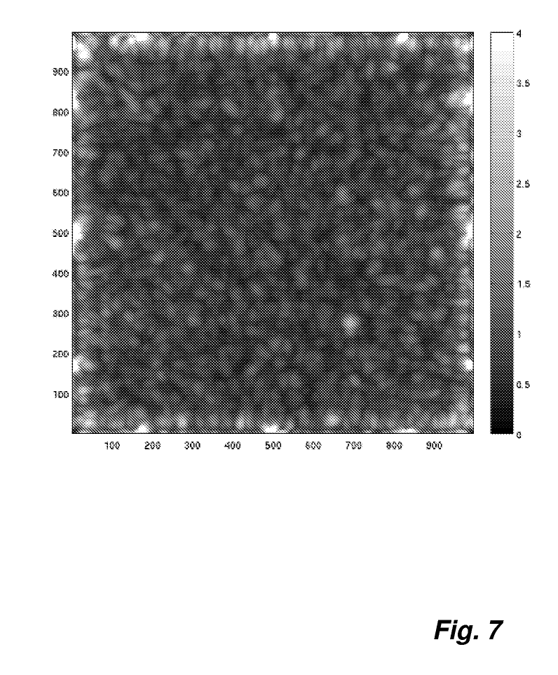

with this imaging condition it is possible to locate unambiguously both sources used in our forward computation using a concrete model as illustrated with FIG. 6. Note that is the case for the source time reverse modeling based on effective elastic properties. The amplitudes are normalized to the mean of all amplitudes. The two original source positions at (400, 300) 603 and (400, 500) 601 can be clearly identified (in FIG. 6). FIG. 7 is an illustration of random input data for the maximum energy density imaging condition. Also note that this is a stress and strain imaging condition, not a velocity or acceleration imaging condition like “energy current density” that has been defined elsewhere as the maximum of {|ν_{z}( x̅,t)|²}.

Maximum stress components usable for creating imaging conditions: The stress tensor σᵢⱼ is determined every time step within the used FD algorithm (Saenger et al., 2000). This allows for the implementation of the maximum value of each component of the stress tensor as an imaging condition. These imaging conditions can especially be used to characterize the source. Goal is to determine the moment tensor of the sources for tε[0,T]:

Stressfieldᵢⱼ(x):=max|σᵢⱼ(t). (13)

The source characteristics (see equation 2 and 3) are visible in the stressfield_{zz}, stressfield_{zx} and stressfieldₓₓ, as well. For example because the source component Mzz was set to zero in equation 2, using stressfield_{zz} does not allow for identification of the original source positions (now shown). However, the stressfield_{xz} application does allow for some localization at the proper source origins, while stressfieldₓₓ does a reasonably good job of accurately allowing for the localization of the original source positions.

Other imaging conditions for sources which are more or less continuous in time (e.g. tremor like sources) with mean as an operator to calculate the harmonic, geometric or arithmetic mean:

trmfieldmean(x):=mean∥ u̅(x,t)∥ for tε[0,T] (14)

pefieldmean(x):=mean(λ+2μ)[∇· u̅(x,t)]² (15)

sefieldmean(x):=meanμ[∇× u̅(x,t)]² (16)

gefieldmean(x):=meanΣᵢΣⱼσᵢⱼ(x,t)εᵢⱼ(x,t) (17)

stressfieldmeanᵢⱼ(x):=mean|σᵢⱼ(t) (18)

Time reverse modeling using the elastodynamic wave equation is, due to the increasing computational possibilities, fast and accurate. The rotated staggered FD grid is used to calculate effective elastic properties of concrete. The numerical modeling can be considered as an efficient and well controlled computer experiment. The numerical simulations show that source areas and characteristics of seismic emissions can be located using TRM. The maximum total energy density imaging condition is the most powerful approach for the determination of source locations (see FIG. 6). The maximum stress component imaging conditions can be used to estimate the moment tensor of the sources. For the localization and characterization of more continuous sources (e.g. tremor-like sources) replacing the maximum-operator (max) in the imaging conditions (equations 9 to 13) with an operator calculating the harmonic, geometric or arithmetic mean may be suggested (equations 14 to 18). This approach is ready to be applied in the laboratory for a deeper understanding of experiments in the area of non-destructive testing. This demonstrates that with a limited number of sensors and an effective homogeneous elastic model time reverse localization and characterization is possible. This methodology can be applied to other related problems, like seismic emission, localization and characterization as outlined in this disclosure.

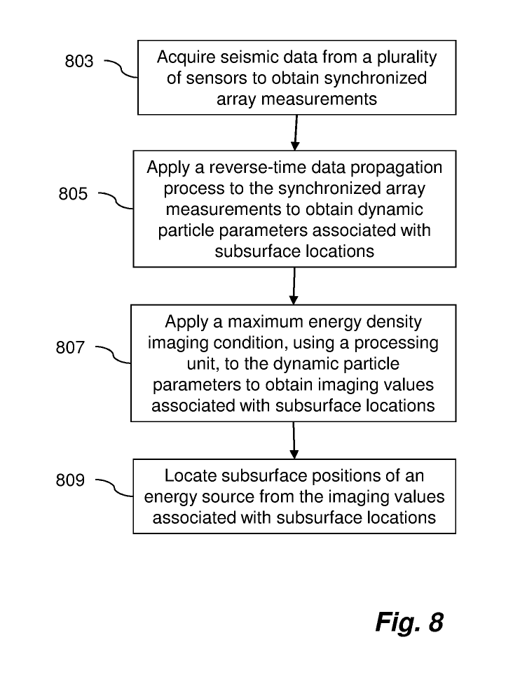

As illustrated in FIG. 8, in one non-limiting embodiment a method and system for processing synchronous array seismic data includes acquiring synchronous seismic data from a plurality of sensors to obtain synchronized array measurements 803. A reverse-time data process is applied to the synchronized array measurements to obtain a plurality of dynamic particle parameters associated with subsurface locations 805. A maximum energy density imaging condition, using a processing unit, is applied to the dynamic particle parameters to obtain imaging values associated with subsurface locations 807. The dynamic particle parameters may be particle displacement values, particle velocity values, particle acceleration values or particle pressure values. The sensors may be three-component sensors. Zero-phase frequency filtering of different ranges of interest may be applied. The data may be resampled to facilitate efficient data processing. The subsurface location of an energy source is located from the imaging values associated with subsurface locations 809.

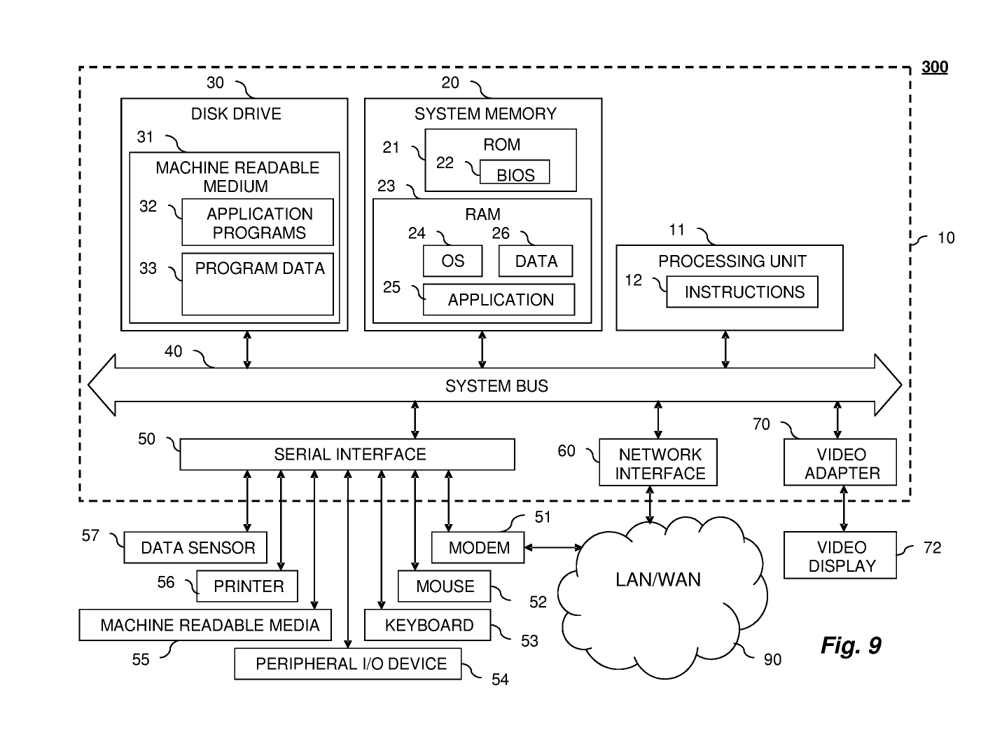

FIG. 9 is illustrative of a computing system and operating environment for implementing a general purpose computing device in the form of a computer 10. Computer 10 includes a processing unit 11 that may include ‘onboard’ instructions 12. Computer 10 has a system memory 20 attached to a system bus 40 that operatively couples various system components including system memory 20 to processing unit 11. The system bus 40 may be any of several types of bus structures using any of a variety of bus architectures as are known in the art.

While one processing unit 11 is illustrated in FIG. 9, there may be a single central-processing unit (CPU) or a graphics processing unit (GPU), or both or a plurality of processing units. Computer 10 may be a standalone computer, a distributed computer, or any other type of computer.

System memory 20 includes read only memory (ROM) 21 with a basic input/output system (BIOS) 22 containing the basic routines that help to transfer information between elements within the computer 10, such as during start-up. System memory 20 of computer 10 further includes random access memory (RAM) 23 that may include an operating system (OS) 24, an application program 25 and data 26.

Computer 10 may include a disk drive 30 to enable reading from and writing to an associated computer or machine readable medium 31. Computer readable media 31 includes application programs 32 and program data 33.

For example, computer readable medium 31 may include programs to process seismic data, which may be stored as program data 33, according to the methods disclosed herein. The application program 32 associated with the computer readable medium 31 includes at least one application interface for receiving and/or processing program data 33. The program data 33 may include seismic data acquired according to embodiments disclosed herein. At least one application interface may be associated with calculating a ratio of data components, which may be spectral components, for locating subsurface hydrocarbon reservoirs.

The disk drive may be a hard disk drive for a hard drive (e.g., magnetic disk) or a drive for a magnetic disk drive for reading from or writing to a removable magnetic media, or an optical disk drive for reading from or writing to a removable optical disk such as a CD ROM, DVD or other optical media.

Disk drive 30, whether a hard disk drive, magnetic disk drive or optical disk drive is connected to the system bus 40 by a disk drive interface (not shown). The drive 30 and associated computer-readable media 31 enable nonvolatile storage and retrieval for application programs 32 and data 33 that include computer-readable instructions, data structures, program modules and other data for the computer 10. Any type of computer-readable media that can store data accessible by a computer, including but not limited to cassettes, flash memory, digital video disks in all formats, random access memories (RAMs), read only memories (ROMs), may be used in a computer 10 operating environment.

Data input and output devices may be connected to the processing unit 11 through a serial interface 50 that is coupled to the system bus. Serial interface 50 may a universal serial bus (USB). A user may enter commands or data into computer 10 through input devices connected to serial interface 50 such as a keyboard 53 and pointing device (mouse) 52. Other peripheral input/output devices 54 may include without limitation a microphone, joystick, game pad, satellite dish, scanner or fax, speakers, wireless transducer, etc. Other interfaces (not shown) that may be connected to bus 40 to enable input/output to computer 10 include a parallel port or a game port. Computers often include other peripheral input/output devices 54 that may be connected with serial interface 50 such as a machine readable media 55 (e.g., a memory stick), a printer 56 and a data sensor 57. A seismic sensor or seismometer for practicing embodiments disclosed herein is a nonlimiting example of data sensor 57. A video display 72 (e.g., a liquid crystal display (LCD), a flat panel, a solid state display, or a cathode ray tube (CRT)) or other type of output display device may also be connected to the system bus 40 via an interface, such as a video adapter 70. A map display created from spectral ratio values as disclosed herein may be displayed with video display 72.

A computer 10 may operate in a networked environment using logical connections to one or more remote computers. These logical connections are achieved by a communication device associated with computer 10. A remote computer may be another computer, a server, a router, a network computer, a workstation, a client, a peer device or other common network node, and typically includes many or all of the elements described relative to computer 10. The logical connections depicted in FIG. 9 include a local-area network (LAN) or a wide-area network (WAN) 90. However, the designation of such networking environments, whether LAN or WAN, is often arbitrary as the functionalities may be substantially similar. These networks are common in offices, enterprise-wide computer networks, intranets and the Internet.

When used in a networking environment, the computer 10 may be connected to a network 90 through a network interface or adapter 60. Alternatively computer 10 may include a modem 51 or any other type of communications device for establishing communications over the network 90, such as the Internet. Modem 51, which may be internal or external, may be connected to the system bus 40 via the serial interface 50.

In a networked deployment computer 10 may operate in the capacity of a server or a client user machine in server-client user network environment, or as a peer machine in a peer-to-peer (or distributed) network environment. In a networked environment, program modules associated with computer 10, or portions thereof, may be stored in a remote memory storage device. The network connections schematically illustrated are for example only and other communications devices for establishing a communications link between computers may be used.

While various embodiments have been shown and described, various modifications and substitutions may be made thereto without departing from the spirit and scope of the disclosure herein. Accordingly, it is to be understood that the present embodiments have been described by way of illustration and not limitation.

We claim:

1. A method for processing synchronous array seismic data comprising:
a) acquiring seismic data from a plurality of sensors to obtain synchronized array measurements;
b) applying a reverse-time data propagation process to the synchronized array measurements to obtain dynamic particle parameters associated with subsurface locations;
c) applying a maximum energy density imaging condition, using a processing unit, to the dynamic particle parameters to obtain imaging values associated with subsurface locations; and
d) locating a subsurface position of an energy source from a relative maximum of a plurality of the imaging values associated with subsurface locations.

2. The method of claim 1 further comprising storing the imaging values in a form for display.

3. The method of claim 1 further comprising selecting seismic data without reference to phase information of the seismic data.

4. The method of claim 1 wherein the plurality of dynamic particle parameters are at least one selected from the group consisting of i) particle velocity values, ii) particle acceleration values and iii) particle pressure values.

5. The method of claim 1 wherein the plurality of sensors are three-component sensors.

6. The method of claim 1 further comprising applying a zero-phase frequency filter to the synchronized array measurements.

7. The method of claim 1 further comprising an extrapolator selected from a group consisting of i) finite-difference reverse time migration, ii) ray-tracing reverse time migration and iii) pseudo-spectral reverse time migration.

8. A set of application program interfaces embodied on a computer readable medium for execution on a processor in conjunction with an application program for applying a reverse-time data process to synchronized seismic data array measurements to obtain subsurface image values associated with subsurface energy source locations comprising:
a first interface that receives synchronized seismic data array measurements;
a second interface that receives a dynamic particle parameter output from reverse-time data processing of the synchronized seismic data array measurements; and
a third interface that receives a maximum energy density image value associated with a subsurface location, the value output applying a maximum energy density imaging condition to the dynamic particle parameters.

9. The set of application interface programs according to claim 8 further comprising:
a zero-phase filter interface that receives instruction data for applying a zero-phase frequency filter to the synchronized array measurements.

10. The set of application interface programs according to claim 8 further comprising:
an image-display interface that receives instruction data for displaying maximum energy density image values.

11. The set of application interface programs according to claim 8 further comprising:
a resample interface that receives instruction data for resampling the synchronized seismic data array measurements.

12. The set of application interface programs according to claim 8 further comprising:
a sixth interface that receives instruction data for the plurality of dynamic particle parameters that are at least one selected from the group consisting of i) particle velocity values, and ii) particle acceleration values and iii) particle pressure values.

13. The set of application interface programs according to claim 8 further comprising:
a elastic-property interface that receives instructions data for processing using effective elastic properties.

14. The set of application interface programs according to claim 8 further comprising:
an extrapolator interface that receives instruction data for including an extrapolator for at least one selected from the group of i) finite-difference reverse time migration, ii) ray-tracing reverse time migration and iii) pseudo-spectral reverse time migration.

15. An information handling system for determining the presence of subsurface hydrocarbons associated with an area of seismic data acquisition comprising:
a) a processor configured for applying a reverse-time data process to synchronized array measurements of seismic data to obtain a plurality of dynamic particle parameters associated with subsurface locations;
b) a processor configure for applying a maximum energy density imaging condition to the plurality of dynamic particle parameters to obtain maximum energy density imaging values; and
c) a computer readable medium for storing at least one of the maximum energy density imaging values.

16. The information handling system of claim 15 wherein the processor is configured to apply the reverse-time data process with predetermined velocity information associated with subsurface locations.

17. The information handling system of claim 15 further comprising a display device for displaying the maximum energy density imaging values.

18. The information handling system of claim 15 further comprising a processing configured to select array data without reference to phase information.

19. The information handling system of claim 15 wherein the processor is configured to apply the reverse-time data process with an extrapolator for at least one selected from the group of i) finite-difference reverse time migration, ii) ray-tracing reverse time migration and iii) pseudo-spectral reverse time migration.

20. The information handling system of claim 15 further comprising:
a graphical display coupled to the processor and configured to present a view of the maximum energy density imaging values as a function of position.
